(19) United States
(12) Patent Application Publication
(10) Pub. No.: US 2008/0316775 A1
(43) Pub. Date: Dec. 25, 2008

(54) Soft-switching circuit for power supply

(75) Inventors: Hsien-Yi Tsai, Jiali Town (TW); Dan Chen, Taipei City (TW); Tsun-Hsiao Hsia, Taipei City (TW)

Correspondence Address: TROXELL LAW OFFICE PLLC, SUITE 1404, 5205 LEESBURG PIKE, FALLS CHURCH, VA, 22041, US

(73) Assignee: Lead Year Enterprise Co., Ltd.

(21) Appl. No.: 11/812,972

(22) Filed: Jun. 22, 2007

(51) Int. Cl. H02M 3/335; H02M 7/06

(52) U.S. Cl. 363/21.01; 363/126

(57) ABSTRACT

A soft-switching circuit for a power supply comprises a bridgeless rectifier circuit and an auxiliary circuit. The auxiliary circuit is connected to the bridgeless rectifier circuit, which comprises at least one filtering inductor, two main switches, two diodes and a capacitor. The filtering inductor is connected to the first diode. The first diode is connected to the second diode. The second diode is connected to the first main switch. The first main switch is connected to the second main switch. The diodes and the main switches are connected in parallel with the capacitor to reduce conducting loss. The auxiliary circuit comprises at least one resonant inductor, an auxiliary switch, at least two diodes and a voltage source circuit. The diodes are connected to the resonant inductor and further connected to the voltage source circuit. The voltage source circuit is connected to the auxiliary switch, whereby the soft-switching circuit can accomplish zero voltage switching and zero current switching to provide low conducting loss and low switching loss.

### FIELD OF THE INVENTION

The present invention relates to a soft-switching circuit for a power supply that connects an auxiliary circuit to a bridgeless rectifier circuit to accomplish the soft switching with zero voltage transition for reducing switching loss and simultaneously providing low conducting loss and low switching loss which suitable for use in a power supply or the like.

### BACKGROUND OF THE INVENTION

Due to the development of technology, the power has wider applications. The power supplies are indispensable to more and more products. For example, personal computers, industrial computers, switches, printers and so forth require respective AC/DC converters to turn on the power source.

Most existing power supplies employ boost-type power converter that employ power factor correction. The boost-type power converter transforms AC current into DC current by a bridge rectifier, and it is operated in a boost-type converter mode. It has two operation states. In first state, when the switch is turned on, the inductor can store the energy. In the second state, when the switch is turned off, the inductor can release the energy to a load via a diode and change the continuous input current into a sine wave by using power factor regulation technology so as to achieve the purpose of regulating output voltage and input current.

In addition, the FIG. 2 shows a bridgeless boost-type power converter that employs power factor correction so as to remove the bridge rectifier from the front end. In addition, the AC current can be transformed into the DC current directly by using power factor regulation technology so as to obtain good voltage regulation property. In addition, the input current can be regulated to approach the sine wave. The bridge rectifier is omitted so the conducting loss is smaller.

However, the power converters shown in both FIG. 1 and FIG. 2 have larger switching loss and magnetic interference when they are operated in high frequency.

In view of the above-mentioned drawbacks, the present inventor makes diligent studies in providing general public with a soft-switching circuit for a power supply that connects an auxiliary circuit to a bridgeless rectifier circuit to provide low conducting loss and low switching loss.

### SUMMARY OF THE INVENTION

It is a primary object of the present invention to provide a soft-switching circuit for a power supply that connects an auxiliary circuit to a bridgeless rectifier circuit to allow the main switches and the auxiliary switch to accomplish zero voltage switching and zero current switching respectively for providing low conducting loss and low switching loss.

It is a secondary object of the present invention to provide a soft-switching circuit for a power supply that removes a bridge rectifier from an input terminal by providing a bridgeless rectifier circuit to reduce conducting loss and to provide the circuit with low conducting loss.

In order to achieve the foregoing objects, a soft-switching circuit for a power supply of the present invention is comprised of a bridgeless rectifier circuit and an auxiliary circuit. The auxiliary circuit is connected to the bridgeless rectifier circuit, which comprises at least one filtering inductor, two main switches, two diodes and a capacitor. The filtering inductor is connected to the first diode. The first diode is connected to the second diode. The second diode is connected to the first main switch. The first main switch is connected to the second main switch. The two diodes and the two main switches are connected in parallel with the capacitor to reduce conducting loss. The auxiliary circuit comprises at least one resonant inductor, an auxiliary switch, at least two diodes and a voltage source circuit. The diodes are connected to the resonant inductor and further connected to the voltage source circuit. The voltage source circuit is connected to the auxiliary switch, whereby the soft-switching circuit can accomplish zero voltage switching and zero current switching to provide low conducting loss and low switching loss.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is a schematic diagram showing a first embodiment of the prior art.

FIG. 2 is a schematic diagram showing a second embodiment of the prior art.

FIG. 3 is a schematic block diagram showing the circuit of the present invention.

FIG. 4 is a circuit diagram showing a first preferred embodiment of the present invention.

FIG. 5 is a circuit diagram showing a second preferred embodiment of the present invention.

FIG. 6 is a circuit diagram showing a third preferred embodiment of the present invention.

FIG. 7 is a circuit diagram showing a fourth preferred embodiment of the present invention.

FIG. 8 is a circuit diagram showing a fifth preferred embodiment of the present invention.

FIG. 9 is a circuit diagram showing a sixth preferred embodiment of the present invention.

FIG. 10 is a circuit diagram showing the operation modes of the present invention.

FIG. 11 is a waveform diagram showing the operation modes of the present invention.

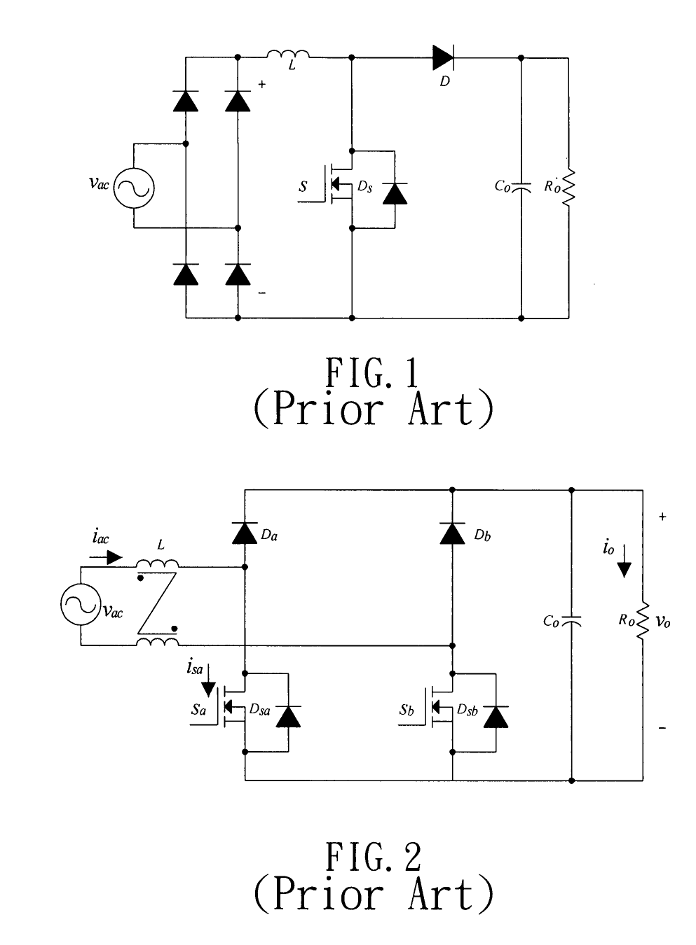

### DETAILED DESCRIPTION OF THE PREFERRED EMBODIMENT

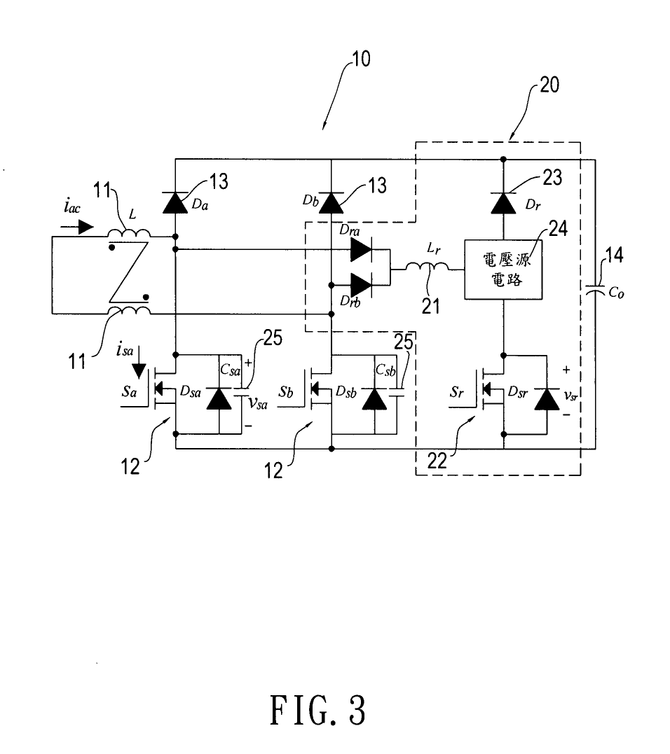

Referring to FIG. 3, a soft-switching circuit for a power supply of the present invention generally comprises a bridgeless rectifier circuit 10 and an auxiliary circuit 20. The auxiliary circuit 20 is connected to the bridgeless rectifier circuit 10. The bridgeless rectifier circuit 10 comprises at least one filtering inductor 11, two main switches 12, two diodes 13 and a capacitor 14. The filtering inductor 11 is connected to the first diode 13. The filtering inductor 11 is a coupled filtering inductor or an uncoupled filtering inductor. The first diode 13 is connected to the second diode 13. The second diode 13 is connected to the first main switch 12. The first main switch 12 is connected to the second main switch 12. The diodes 13 and the main switches 12 are connected in parallel with the capacitor 14 so that a bridge rectifier can be removed from an input terminal to reduce conducting loss. The auxiliary circuit 20 comprises at least one resonant inductor 21, an auxiliary switch 22, at least two diodes 23 and a voltage source circuit 24, wherein the at least two diodes 23 are connected to the resonant inductor 21, and further connected to the voltage source circuit 24. The voltage source circuit 24 is further connected to the auxiliary switch 22. In addition, the auxiliary circuit 20 further comprises a resonant capacitor or alternatively uses the parasitic capacitor 25 of the main switch or the auxiliary switch itself to allow the resonant inductor 21 to accomplish the resonance within this time period, wherein the main switches 12 of the bridgeless rectifier circuit 10 and the auxiliary switch 22 of the auxiliary circuit 20 are Metal-Oxide-Semiconductors or Insulated Gate Bipolar Transistors each connect in parallel with a respective capacitor and a respective diode or uses the parasitic capacitor or the diode of the switch itself. In addition, other switch devices may be employed to replace the above-mentioned devices. In other words, during every switching period, the conducting timing of the control signal of the main switch 12 of the bridgeless rectifier circuit 10 is given with a delay time, and the conducting time of the auxiliary switch 22 is inserted in the delay time to allow the resonant inductor 21 to accomplish the resonance within the delay time, thereby accomplishing the soft switching with zero voltage transition for reducing conducting loss.

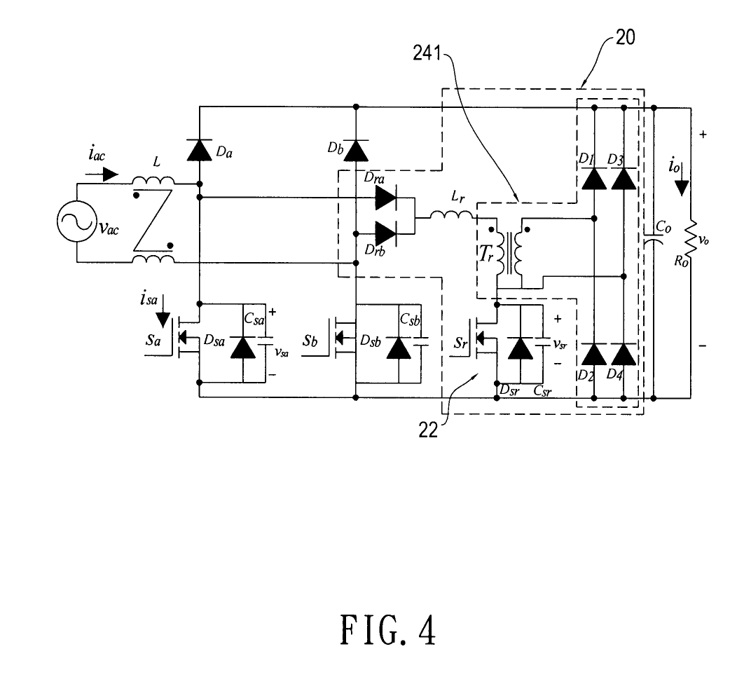

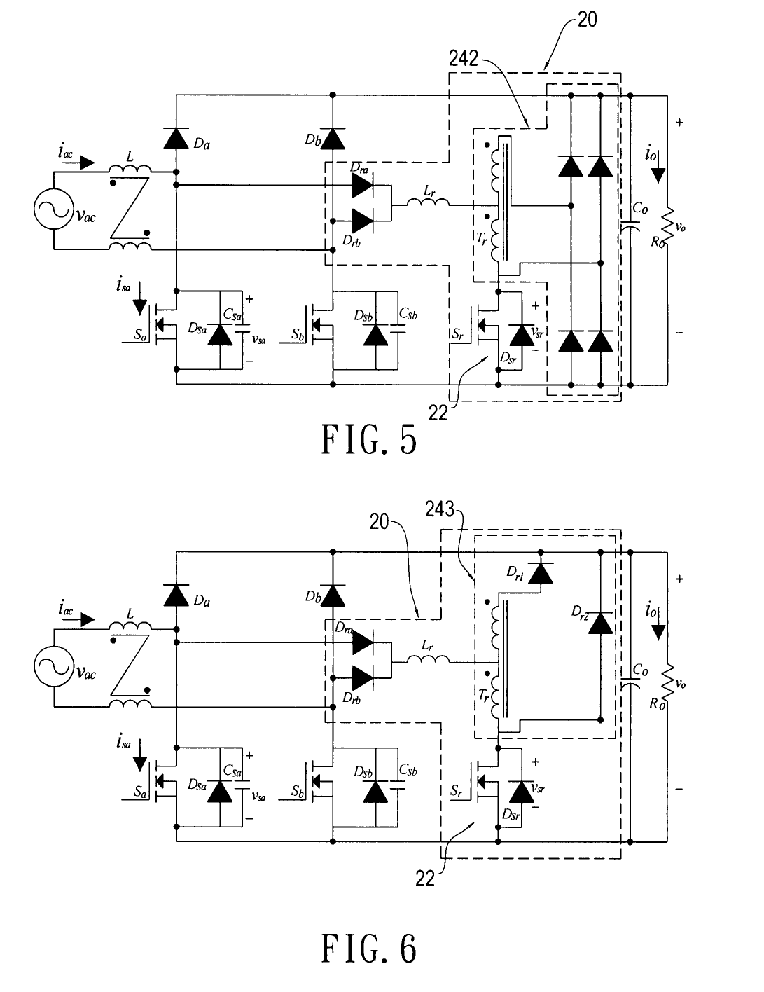

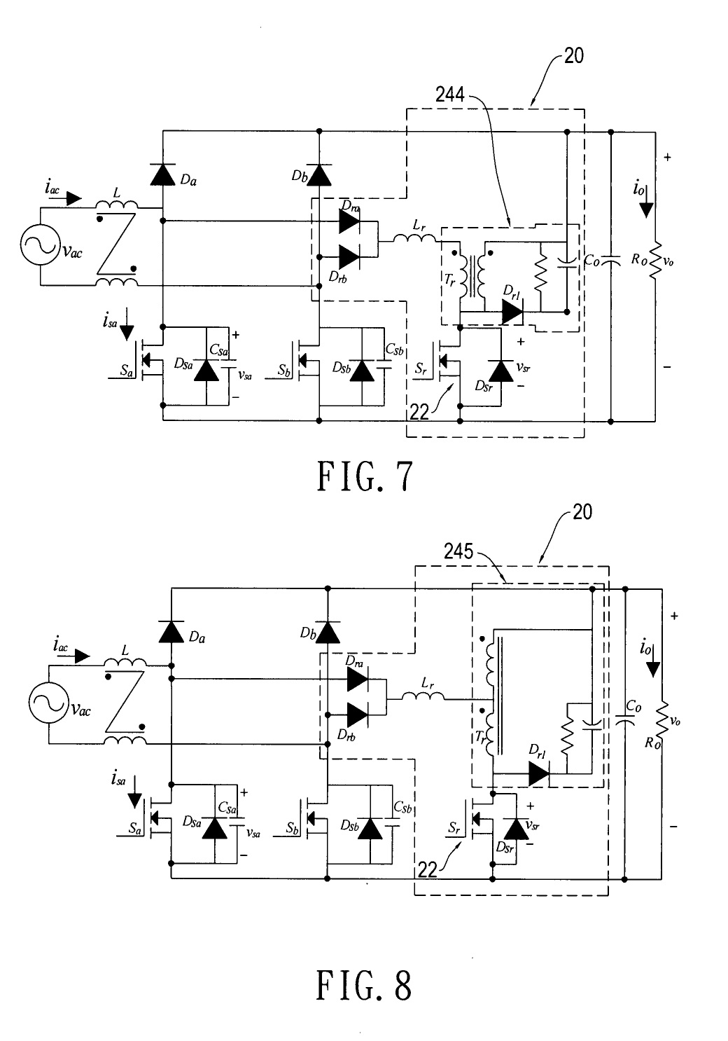

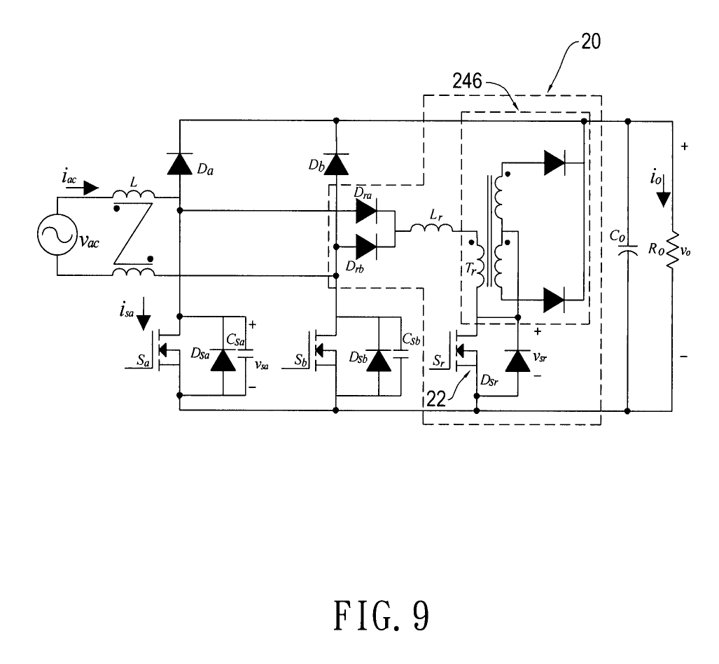

Referring to FIGS. 3 through 9, switching power circuits in accordance with the preferred embodiments of the present invention is shown. In the soft-switching circuit, the input current is an AC current divided into a positive half cycle and a negative half cycle. In addition, its operation can be classified into two major modes. In these preferred embodiments, the discussions are made mainly on the soft-switching operation, which has the same working principle in these two major modes. It is assumed that the input power is in the positive half cycle before analyzing the soft-switching operation. Since the switching period is very short, it is assumed that the boost inductance L is so large that its current can be regarded as a constant current source and that the output filtering capacitance C is so large that the voltage can be regarded as a constant voltage source, i.e. iᵢ=Iᵢ and v₀=V₀, wherein the capacitor Cₛᵣ and the diode D₄ are still remained to facilitate analysis. In the practical application, the resonant capacitor can be replaced by the parasitic capacitor Cₛₐ or C_{sb} of main switch Sₐ or S_{b} and the diode can be replaced by the body diode Dₛₐ or D_{sb} of main switch Sₐ or S_{b}. The power circuit can accomplish the zero current switching (ZCS) by using the auxiliary switch 22 of the additional auxiliary circuit 20. According to such a conception, the voltage source circuit 24 is connected thereto in series. The voltage source circuit 24 is provided by and parallel-connecting a transformer to the output. In addition, the constant voltage source is outputted to induce a constant voltage on the auxiliary circuit to help the auxiliary switch 22 accomplishes the zero current switching (ZCS). The transformer can be in additive or subtractive polarity. For example, FIG. 4 shows a subtractive polarity self-coupled full-bridge transformer circuit 241, which is composed of four diodes and a subtractive polarity transformer. FIG. 5 shows an additive polarity self-coupled full-bridge transformer circuit 242, which is composed of four diodes and an additive polarity transformer. FIG. 6 shows an additive polarity transformer circuit 243. FIG. 7 shows a subtractive polarity self-coupled transformer circuit 244, which is composed of a diode, a resistor, a capacitor and a subtractive polarity transformer. FIG. 8 shows an additive polarity self-coupled transformer circuit 245, which is composed of a diode, a resistor, a capacitor and an additive polarity transformer. FIG. 9 shows a center-tapped transformer circuit 246, which is composed of two diodes and a center-tapped transformer. The foregoing discloses different embodiments of the present invention.

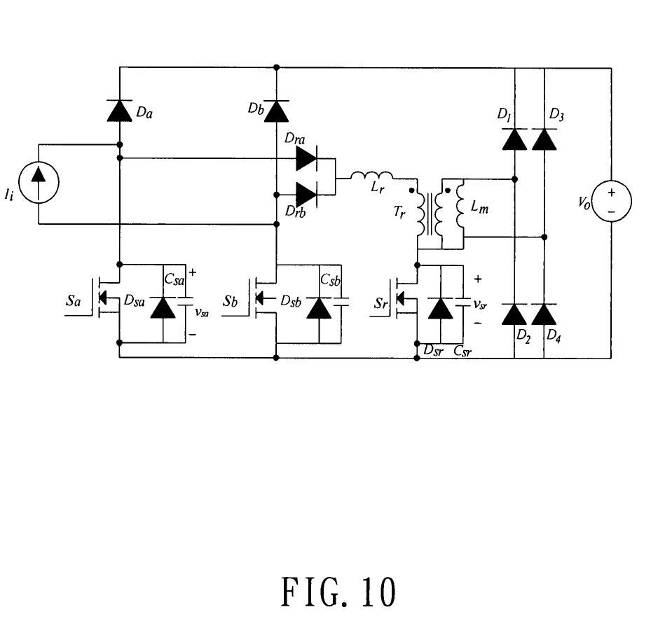

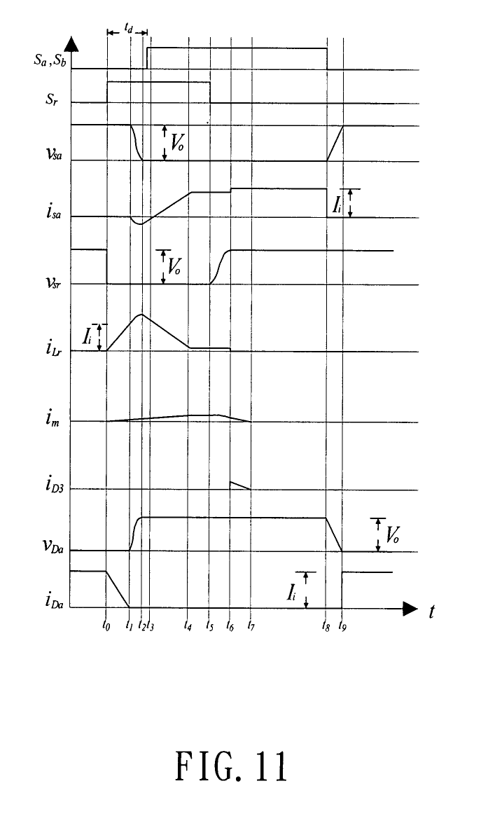

FIG. 10 is a circuit diagram showing the operation modes of the present invention. The operation modes can be divided into ten modes for analysis. The respective waveforms of the critical parameters are schematically shown in FIG. 11. The respective operation conditions of these modes are briefly described below.

Mode 0 (t₉˜t₀): During the period of t₉≦t≦t₀, the main switches S and the auxiliary switch Sᵣ are turned off, the input current Iᵢ flows to a load via the diode Dₐ, and then flows back to the input via the body diode of S_{b}. In the diode Dₐ, when current i_{Da}=Iᵢ, the voltage across the main switches is (i.e. resonant capacitor voltage) vₛ=Vₒ. Mode 1 (t₀˜t₁): When t=t₀, the main switches S are delayed and the auxiliary switch Sᵣ is turned on to enter the mode 1, Dᵣₐ conduced. At this moment, the current i_{Lr} flows through the winding Nₚ of Dᵣₐ, Lᵣ and Tᵣ to create an induced current iₛ in the winding Nₛ, wherein the induced current iₛ flows to Vₒ via D₁ and returns via D₄. At this moment, the Tᵣ crosses the constant voltage source Vₒ at a secondary side and the magnetizing current iₘ ascends linearly so it can induce the constant voltage source at a primary side. Besides, since Dₐ is still in the on state, the current i_{Lr} starts to ascend linearly and the auxiliary switch Sᵣ is soft turn-on. When the current i_{Lr} ascends to Iᵢ, this mode is terminated, i.e. t=t₁. Mode 2 (t₁˜t₂): When the current i_{Lr} ascends to Iᵢ, the diode Dₐ is cut off to enter the mode 2. At this mode, the auxiliary switch is maintained in the on state, and the resonant inductor and the resonant capacitor form a tank circuit jointly. The inductance and the current keep ascending, and the resonant capacitor voltage namely the main switch voltage (vₛ) descends. When vₛ descends from Vₒ to zero, this mode is terminated, i.e. t=t₂. Mode 3 ( t₂˜t₃): When t=t₂, the resonant capacitor voltage (vₛ) descends to zero to enter the mode 3 and the resonant capacitor voltage keeps descending, causing the body diode Dₛₐ of the main switch to be conduced so that the current i _{Lr} starts to descend linearly and the current iₛₐ starts to ascend linearly. At this moment, the main switch voltage is zero. When t≧t₂, the main switch Sₐ can be triggered and turned on under the zero voltage switching (ZVS) condition. When the current iₛₐ ascends from a negative value to zero, this mode is terminated, i.e. t=t₃. Mode 4 (t₃˜t₄): When t=t₃, the current iₛₐ ascends from a negative value to zero, the body diode Dₛₐ of the main switch is turned off to enter the mode 4. At this moment, iₛₐ keeps ascending linearly from zero and the current i_{Lr} keeps descending linearly so that the energy stored in the resonant inductor Lᵣ can be released to the load by means of Tᵣ. When i_{Lr} descends to the magnetizing current iₘ, this mode is terminated, i.e. t=t₄. Mode 5 (t₄˜t₅): When t=t₄, i_{Lr} descends to the magnetizing current iₘ. At this moment, the span voltage Tᵣ is equal to zero, the diodes D₁ and D₄ are cut off, and the diode D₂ is conduced. The iₘ flows circularly from the primary side and the secondary side via Sᵣ. However, the magnetizing current is generally designed to be considerably smaller than the load current so the current that flows through the auxiliary switch Sᵣ can be regarded as a zero current. When t≧t₄ the auxiliary switch Sᵣ can be turned off under the zero current switching (ZCS) condition so as to terminate this mode, i.e. t=t₅. Mode 6 (t₅˜t₆): When t=t₅, the auxiliary switch is turned off to enter the mode 6. At this moment, the magnetizing current iₘ can charge the parasitic capacitor Cₛᵣ of the auxiliary switch Sᵣ to ascend the voltage vₛᵣ. When the voltage vₛᵣ ascends to V₀, D₃ and D₂ are conduced and this mode is terminated, i.e. t=t₆. Mode 7 (t₆˜t₇): When t=t₆, the voltage vₛᵣ ascends to V₀ to enter the mode 7. At this moment, D₃ and D₂ are conduced, the magnetizing inductance Lₘ has a span voltage V₀ to allow the magnetizing current iₘ to be descended linearly. When the magnetizing current iₘ descends linearly to zero, Tᵣ accomplishes reset and this mode terminates, i.e. t=t₇. Mode 8 (t₇˜t₈): When t=t₇, the magnetizing current iₘ descends linearly to zero to enter the mode 8, and the diodes D₃ and D₂ are both cut off. At this moment, the main switch is still in the on state, and the inductor L can store the energy to enter an operation condition that the main switch of the general boost converter is full turned on. When the main switch is turned off, this mode is terminated, i.e. t=t₈. Mode 9 (t₈˜t₉): When t=˜t₈, the main switch is turned off to enter the mode 9. At this moment, the constant current Iᵢ can charge the resonant capacitor Cₛₐ to ascend the switching voltage linearly. When the capacitor voltage reaches the output voltage V₀, this mode is terminated, and the diode Dₐ is conduced. At this moment, vₛₐ=V₀ and the mode 0 is returned to start another switching period.

According to the foregoing analysis, the additional auxiliary circuit mentioned above allows the main switch to accomplish the zero voltage switching (ZVS) when it is in the on state. In addition, the auxiliary switch is soft turn-on when it is in the on state and it can accomplish the zero voltage switching (ZVS) when it is in the off state. For the same reason, when the input current is in the negative half cycle, the input current flows through another route so the identical auxiliary circuit can be employed to accomplish zero voltage switching and zero current switching. As a result, the above-mentioned bridgeless soft-switching circuit can improve the switching loss of the circuit switch effectively, thereby promoting the efficiency of the converter.

In accordance with the foregoing description, the present invention has the following practical advantages:

1. The auxiliary circuit gives the delay time to the conducting timing of the control signal of the main switch of the bridgeless rectifier circuit during every switching period, and the present invention inserts the conducting time of the auxiliary switch in the delay time to allow the resonant inductor to accomplish the resonance within the delay time so as to accomplish the soft-switching operation with zero voltage transition for reducing switching loss.

2. The present invention connects the auxiliary circuit to the bridgeless rectifier circuit so as to allow the main switch and the auxiliary switch to accomplish the zero voltage switching and the zero current switching respectively for providing low conducting loss and low switching loss.

To sum up, the present invention is capable of achieving the anticipated objects described above. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A soft-switching circuit for a power supply, comprising:
a bridgeless rectifier circuit comprising at least one filtering inductor, a first main switch, a second main switch, a first diode, a second diode and a capacitor, said filtering inductor being connected to said first diode, said first diode being connected to said second diode, said second diode being connected to said first main switch, said first main switch being connected to said second main switch, said first and second diodes and said first and second main switches being connected in parallel with said capacitor to reduce conducting loss; and
an auxiliary circuit connected to said bridgeless rectifier circuit, said auxiliary circuit comprising at least one resonant inductor, an auxiliary switch, at least two diodes and a voltage source circuit, said two diodes being connected to said resonant inductor and further connected to said voltage source circuit, said voltage source circuit being connected to said auxiliary switch, whereby said soft-switching circuit can accomplish zero voltage switching and zero current switching so as to provide low conducting loss and low switching loss.

2. A soft-switching circuit for a power supply according to claim 1, wherein said filtering inductor of said bridgeless rectifier circuit is a coupled filtering inductor.

3. A soft-switching circuit for a power supply according to claim 1, wherein said filtering inductor of said bridgeless rectifier circuit is an uncoupled filtering inductor.

4. A soft-switching circuit for a power supply according to claim 1, wherein said first and second main switches of said bridgeless rectifier circuit and said auxiliary switch of said auxiliary circuit are Metal-Oxide-Semiconductors each connect in parallel with a respective capacitor and a respective diode.

5. A soft-switching circuit for a power supply according to claim 1, wherein said first and second main switches of said bridgeless rectifier circuit and said auxiliary switch of said auxiliary circuit are Insulated Gate Bipolar Transistors each connect in parallel with a respective capacitor and a respective diode.

6. A soft-switching circuit for a power supply according to claim 1, wherein said auxiliary switch further comprises a resonant capacitor.

7. A soft-switching circuit for a power supply according to claim 1, wherein said first and second main switches of said bridgeless rectifier circuit and said auxiliary switch of said auxiliary circuit each further comprise a respective parasitic capacitor.

8. A soft-switching circuit for a power supply according to claim 1, wherein said voltage source circuit of said auxiliary circuit is a subtractive polarity self-coupled full-bridge transformer circuit consisting of four diodes and a subtractive polarity transformer.

9. A soft-switching circuit for a power supply according to claim 1, wherein said voltage source circuit of said auxiliary circuit is an additive polarity self-coupled full-bridge transformer circuit consisting of four diodes and an additive polarity transformer.

10. A soft-switching circuit for a power supply according to claim 1, wherein said voltage source circuit of said auxiliary circuit is an additive polarity transformer circuit consisting of two diodes and an additive polarity transformer.

11. A soft-switching circuit for a power supply according to claim 1, wherein said voltage source circuit of said auxiliary circuit is a subtractive polarity self-coupled transformer circuit consisting of a diode, a resistor, a capacitor and a subtractive polarity transformer.

12. A soft-switching circuit for a power supply according to claim 1, wherein said voltage source circuit of said auxiliary circuit is an additive polarity self-coupled transformer circuit consisting of a diode, a resistor, a capacitor and an additive polarity transformer.

13. A soft-switching circuit for a power supply according to claim 1, wherein said voltage source circuit of said auxiliary circuit is a center-tapped transformer circuit consisting of two diodes and a center-tapped transformer.
